(19) United States
(12) Patent Application Publication
(10) Pub. No.: US 2008/0243518 A1
(43) Pub. Date: Oct. 2, 2008

(54) System And Method For Compressing And Reconstructing Audio Files

(76) Inventors: Alexey Oraevsky, Waterloo (CA); Dmitry Vatolin, Moscow (RU); Alexey Sergeevich Lukin, Moscow (RU); Eugeny Shelwein, Kharkov (UA); Alexey Martynov, Sarov (RU); Victor Tyakht, Moscow (RU)

Correspondence Address: DARYL W SCHNURR;MILLER THOMSON LLP, ACCELERATOR BUILDING, 295 HAGEY BLVD., SUITE 300, WATERLOO, ON, N2L 6R5, CA

(21) Appl. No.: 11/560,835

(22) Filed: Nov. 16, 2006

(51) Int. Cl. G10L 19/00

(52) U.S. Cl. 704/500; 704/E19.01

(57) ABSTRACT

A system and method for the improved compression of audio signals and the restoration and enhancement of audio recordings missing high frequency content. In the preferred embodiment the different context models are applied to increase the compression ratio of spectral information, quantization coefficients and other information. Context models and arithmetic compression are used for final compression. The time-frequency amplitude envelope and degree of tonality parameters are extracted from the low frequency component. An estimate of the high frequency component is performed by applying a multiband distortion effect, waveshaping, to the low frequency content. Control of tonality is achieved by varying the number of bands within the multiband framework. A filterbank is used that roughly shapes the reconstructed high frequency component according to an estimation of the most probable shape.

### FIELD OF THE INVENTION

This invention relates to file compression. In particular, this invention relates to a system and method for compressing and reconstructing audio files.

### BACKGROUND OF THE INVENTION

Compression/decompression (codec) algorithms are used to compress digital files, including text, images, audio and video, for easier storage and faster transmission over network connections. Basic compression involves removing redundant data, leaving enough data to reconstruct the file during decompression with the desired degree of accuracy, or ‘tolerance.’ If the original uncompressed file has a higher resolution than is required for the end use, much non-redundant data can be eliminated because it is unnecessary in the decompressed file; for example, where a high resolution image is only needed for display on a computer monitor (which typically has relatively low resolution), the image file can lose a lot of data without sacrificing the quality of the final image.

Similarly, in the case of most audio files, some data that is not redundant can nevertheless be eliminated during compression because some of the frequencies represented by the data are either not perceivable or not discernable by the human ear. The psychoacoustic characteristics of the human ear are such that ultra-high and ultra-low frequencies are beyond its perceptual capabilities, and tones that are very close together in pitch are often not discemable from one another so the human ear perceives only a single tone anyway. Codecs which take advantage of this phenomenon, including the very popular MP3 codec, are known as “perceptual audio codecs.” Such a codec analyzes the source audio, compares it to psychoacoustic models stored within the encoder, and discards data that falls outside the models.

With the widespread use of perceptual audio codecs, the problem of high frequency reconstruction has become of great importance. When digitally encoding an audio signal, the high frequency portion of the signal occupies a disproportionately large part of the encoded bit stream. To faithfully capture the high frequency content in the encoded signal, a very large amount of data would required to accurately represent the original, uncompressed audio signal.

One known method of increasing the compressibility of the encoded signal is to take advantage of the correlation between the high and low frequency components. Since these two components are correlated, it is possible to filter out the high frequency component at the encoder, transmit only the low frequency component and reconstruct the high frequency component at the decoder to generate an approximation of the original audio signal. Including additional information that describes the correlation between the low and high frequency components with the transmitted low frequency component enables a more faithful reconstruction of the original audio signal.

Lossless compression in MP3 and other like compression formats uses the Huffman algorithm for frame compression of signal data. These techniques have proved to be very popular, since they are able to achieve significant compression of the original audio signal while retaining the ability to produce a reasonably accurate representation of the original signal.

The allocation of the number of bits to be allotted to storing each interval (e.g. second) of sound sets a ‘tolerance’ level that determines the fidelity of the decompressed audio file. Techniques that rely on this are known as “lossy” compression techniques, because data is lost in the compression/decompression process and the fidelity of the reconstructed file depends upon how much data was lost.

The earliest examples of successful high frequency reconstruction in lossy audio encoding are the MP3-Plus and AAC-Plus standards. Both techniques are based upon a patented spectral bandwidth replication technique. The problem with this approach is that for highly harmonic signals the high frequency content is not always harmonically correlated to the low frequency content. Thus, special treatment of harmonic signals is required. Tonality control is also missing from this approach.

An alternative method is high-frequency reconstruction by linear interpolation. One example of this technique is PlusV™, a completely parametric approach by VLSI Solutions OY. This method reconstructs high frequencies using a two-part harmonic plus noise model. The original audio signal is sent to an encoder. The encoder extracts up to the four most prominent harmonic components, identified as peaks in the short-time magnitude spectrum, and encodes their parameters. The remaining high frequency component in the audio signal is considered to be noise. The high frequency component is encoded by parametrization of its amplitude envelopes in eight frequency bands. The encoded signal consists of only the low frequency component of the original signal and the noise model parameters identified by the encoder. In order to extract a reconstructed signal from the compressed signal, the decoder unpacks the parametric data and reconstructs the high frequencies by generating the corresponding harmonic and noise components of the high frequency signal, without relying on the low frequency component of the audio signal.

Another approach to high frequency reconstruction has been described by Liu, Lee, Hsu, National Chiao Tung University, Taiwan, 2003: “High Frequency Reconstruction by Linear Extrapolation”, which is incorporated herein by reference. Liu et al. suggest using spectral replication, copying filterbank coefficients to generate a “detail spectrum” of the high frequency component of the audio signal, followed by the application of a linearly decaying amplitude envelope, with least-mean-squares estimation of the decay slope from the existing low frequency component. Problems with this approach include the absence of tonality control, non-harmonicity of the restored audio, possible inadequacy of the replicated spectrum block, and the possibly increasing slope of the amplitude envelope.

Ultimately, however, all these techniques are limited in their ability to compress an audio signal since they do not account for temporal relations in the audio signal. Thus, the compressed signal inevitably retains substantial redundancies which must be stored in order for the algorithm to reproduce a reasonably accurate representation of the original uncompressed file.

There is accordingly a need for a compression and reconstruction scheme that accommodates temporal relations in an audio signal to increase compression ratios and improve the accuracy of reconstructed audio signals. There is a further need for a method of reconstruction that can be used on old archived sound files, to reconstruct the high frequency component of the file that had been lost due to limits in recording technology or storage media existing at the time the file was created.

### SUMMARY OF THE INVENTION

The present invention provides a system and method for the improved compression of audio signals. The present invention also provides a system and method for the improvement of perceptual sound quality for audio recordings that are missing high frequency content, for example due to limitations in the storage medium or where the recording was compressed by a lossy audio data compression technique. The method of the invention may thus be used to restore and enhance previously archived audio recordings, where the high frequency component of the original signal has been lost due to limitations in the recording hardware or storage media

The compression method of the invention is capable of being fully automated and does not require pre-initialization for different types of audio data. It is sufficiently flexible to adjust for different sizes of spectral audio data, permitting it to be used with different spectral transforms. The method of the invention is optimized for integer arithmetic, improving calculation efficiency and extending the range of devices that can implement the invention and the range of devices in which the method could be applied, e.g. sound players, dictating machines, cellular phones, wired phones, radio receivers and transmitters, the sound tracks of television receivers and transmitters.

In the present invention, context modeling is applied to all of the main types of audio-data: Modified Discrete Cosine Transform (MDCT), scalefactors, side information. The invention comprises applying context modeling to the data stream and constructed algorithmic models, and the algorithmic optimization of a decoder function. The invention is based upon the use of adaptive arithmetic compression techniques involving increasing the probability of the value coded. Methods of context modelling are used for choosing the table of probability for arithmetic compression.

In the preferred embodiment the system and method of the invention, different context models are applied to increase the compression ratio of spectral information, quantization coefficients and other information. The spectral data is divided into five frequency bands (0 . . . 31 . . . 32 . . . 63, 64 . . . 127, 128 . . . 255, 256 . . . 575), each band corresponding to a different frequency range, and the last ten values for each frequency (statistics) for each band are independently obtained. Compression of spectral data uses the prediction of coefficient values by several preceding frames of audio data by calculating the mean value of the last ten values of MDCT coefficients.

Preferably context models and arithmetic compression are used for final compression. The filtered value of the Nth MDCT coefficient is compared with the largest value of all MDCT coefficients in the band, to which N belongs. The largest value of all MDCT coefficients in the band is obtained from the first iteration. The ratio of those values determines the number of tables used for arithmetic compression.

The invention can be directly applied to spectral data of various characteristics and spectral bands of various frequencies. This includes data obtained by standard algorithms, such as MPEG-2 Layer 3 and MPEG-4 AAC, as well as new compression algorithms.

In the preferred embodiment a rough estimate of the high frequency component is performed by applying a multiband distortion effect, waveshaping, to the low frequency content. This enables the proper harmonic structure, i.e. overtones of the low frequency component, to be re-created in the reconstructed high frequency component. Control of tonality is achieved by means of varying the number of bands within the multiband framework. More bands leads to less inter-modulation distortion, and hence greater tonality.

The use of waveshaping functions, such as Chebychev polynomials, ensures that the number of generated harmonics is limited and no aliasing occurs. A filterbank is used that roughly shapes the reconstructed high frequency component according to an estimation of the most probable shape, performed using only the information extracted from the low frequency component without considering additional information.

To ensure accurate reconstruction of the high frequency component, the time-frequency amplitude envelope and degree of tonality parameters are extracted from the low frequency component.

In one aspect the present invention provides a method for compressing an audio signal, comprising the steps of: a. dividing spectral data corresponding to the audio signal into a plurality of frequency bands, each band corresponding to a different frequency range; b. obtaining a plurality of the last Modified Discrete Cosine Transform (MDCT) coefficients corresponding to the spectral data for each frequency for each band; and c. compressing the spectral data using a prediction of coefficient values in a plurality of frames of audio data by calculating a mean value of the plurality of last MDCT coefficients.

In a further aspect the present invention provides a method for increasing a compression ratio in the compression of an audio signal, comprising compressing scalefactors using MTF-3 method.

In a further aspect the present invention provides a method of reconstructing an audio signal from a set of compressed audio data corresponding to an original audio signal, comprising the steps of: a. time-frequency decomposing the compressed audio data, b. estimating parameters from the audio data comprising at least an amplitude envelope estimated from a modulus of a first set of corresponding filterbank coefficients and a tonality estimated from a magnitude spectrum of a second set of corresponding filterbank coefficients; and c. synthesizing high frequency components of the audio signal by: i) dividing the audio data into several frequency bands, ii) passing each frequency band through a nonlinear wave-shaping distortion effect to generate distorted frequency bands, and iii) summing the distorted frequency bands to form an estimate of the high frequency components.

### BRIEF DESCRIPTION OF THE DRAWINGS

In drawings which illustrate by way of example only a preferred embodiment of the invention,

FIG. 1 is a block diagram showing the MDCT compression scheme.

FIGS. 2A to 2F are plots illustrating the dependencies of the sum of signs on the number of the series.

FIG. 3 is a flow chart showing the sign prediction method used in the invention.

FIG. 4 is a flow chart showing the method used to determine the count0 boundary.

FIG. 5 is a flow chart showing the method of determining the optimal ESC value.

FIG. 6 is a flow chart showing the employment of general statistic gained at the first iteration in magnitude prediction.

FIG. 7 is a flow chart showing the method of coding the general statistic, gained at first iteration.

FIG. 8 is a flow chart showing the implementation of scalefactors in the invention.

FIG. 9 is a flow chart showing the dispersion calculation.

FIG. 10 is a flow chart showing the low frequency filtering by means of a recursive filter.

### DETAILED DESCRIPTION OF THE INVENTION

Some components of the present invention are based upon an extension of known algorithms of arithmetic compression techniques, for example as described in the following U.S. patents, all of which are incorporated herein by reference:

U.S. Pat. No. 4,122,440 Langdon, Jr.; Glenn George (San Jose, Calif.); Rissanen; Jorma Johannen (San Jose, Calif.), Method and means for arithmetic string coding, Oct. 24, 1978;

U.S. Pat. No. 4,286,256 Langdon, Jr.; Glen G. (San Jose, Calif.); Rissanen; Jorma J. (Los Gatos, Calif.), Method and means for arithmetic coding utilizing a reduced number of operations, Aug. 25, 1981;

U.S. Pat. No. 4,295,125 Langdon, Jr.; Glen G. (San Jose, Calif.), Method and means for pipeline decoding of the high to low order pairwise combined digits of a decodable set of relatively shifted finite number of strings, Oct. 13, 1981;

U.S. Pat. No. 4,463,342 Langdon, Jr.; Glen G. (San Jose, Calif.); Rissanen; Jorma J. (Los Gatos, Calif.), Method and means for carry-over control in the high order to low order pairwise combining of digits of a decodable set of relatively shifted finite number strings, Jul. 31, 1984;

U.S. Pat. No. 4,467,317 Langdon, Jr.; Glen G. (San Jose, Calif.); Rissanen; Jorma J. (Los Gatos, Calif.), High-speed arithmetic compression coding using concurrent value updating, Aug. 21, 1984;

U.S. Pat. No. 4,633,490 Goertzel; Gerald (White Plains, N.Y.); Mitchell; Joan L. (Ossining, N.Y.), Symmetrical optimized adaptive data compression/transfer/decompression system, Dec. 30, 1986;

U.S. Pat. No. 4,652,856 Mohiuddin; Kottappuram M. A. (San Jose, Calif.); Rissanen; Jorma J. (Los Gatos, Calif.), Multiplication-free multi-alphabet arithmetic code, Mar. 24, 1987;

U.S. Pat. No. 4,792,954 Arps; Ronald B. (San Jose, Calif.); Karnin; Ehud D. (Kiriat-Motzkin, Ill.), Concurrent detection of errors in arithmetic data compression coding, Dec. 20, 1988;

U.S. Pat. No. 4,891,643 Mitchell; Joan L. (Ossining, N.Y.); Pennebaker; William B. (Carmel, N.Y.), Arithmetic coding data compression/de-compression by selectively employed, diverse arithmetic coding encoders and decoders, Jan. 2, 1990;

U.S. Pat. No. 4,901,363 Toyokawa; Kazuharu (Yanato, JP), System for compressing bi-level data, Feb. 13, 1990;

U.S. Pat. No. 4,905,297 Langdon, Jr.; Glen G. (San Jose, Calif.); Mitchell; Joan L. (Ossining, N.Y.); Pennebaker; William B. (Carmel, N.Y.); Rissanen; Jorma J. (Los Gatos, Calif.), Arithmetic coding encoder and decoder system, Feb. 27, 1990;

U.S. Pat. No. 4,933,883 Pennebaker; William B. (Carmel, N.Y.); Mitchell; Joan L. (Ossining, N.Y.), Probability adaptation for arithmetic coders, Jun. 12, 1990;

U.S. Pat. No. 4,935,882 Pennebaker; William B. (Carmel, N.Y.); Mitchell; Joan L. (Ossining, N.Y.), Probability adaptation for arithmetic coders, Jun. 19, 1990;

U.S. Pat. No. 5,045,852 Mitchell; Joan L. (Ossining, N.Y.); Pennebaker; William B. (Carmel, N.Y.); Rissanen; Jorma J. (Los Gatos, Calif.), Dynamic model selection during data compression, Sep. 3, 1991;

U.S. Pat. No. 5,099,440 Pennebaker; William B. (Carmel, N.Y.); Mitchell; Joan L. (Ossining, N.Y.), Probability adaptation for arithmetic coders, Mar. 24, 1992;

U.S. Pat. No. 5,142,283 Chevion; Dan S. (Haifa, Ill.); Karnin; Ehud D. (Kiryat Motzkin, Ill.); Walach; Eugeniusz (Kiryat Motzkin, Ill.), Arithmetic compression coding using interpolation for ambiguous symbols, Aug. 25, 1992;

U.S. Pat. No. 5,210,536 Furlan; Gilbert (San Jose, Calif.), Data compression/coding method and device for implementing said method, May 11, 1993;

U.S. Pat. No. 5,414,423 Pennebaker; William B. (Carmel, N.Y.), Stabilization of probability estimates by conditioning on prior decisions of a given context, May 9, 1995;

U.S. Pat. No. 5,546,080 Langdon, Jr.; Glen G. (Aptos, Calif.); Zandi; Ahmad (Cupertino, Calif.), Order-preserving, fast-decoding arithmetic coding arithmetic coding and compression method and apparatus, Aug. 13, 1996.

The present invention also makes use of data context modeling methods that have recently been developed, the best known application of context modeling being the Context Arithmetic Based Adaptive Coding (CABAC) algorithm, as implemented in the MPEG-4 AVC standard, which is incorporated herein by reference.

### Definitions

For purposes of this description the following definitions are provided:
“Sign” is the sign of Modified Discrete Cosine Transform (MDCT) coefficient.
“Magnitude” is the magnitude of MDCT coefficient.
“count0” is the region of zero MDCT coefficients (coded by storing only the boundary of this region).
“count0 boundary” is the left boundary of the count0. It is equal to the last nonzero MDCT coefficient position plus one.
“Delta-coding” is storing the difference between a current value and the previous one. A standard implementation has redundancy, concerned with doubling the range of the value to be coded. E.g. if the value to be coded has the range (a . . . b), the difference between the value to be coded and the value previously coded has the range (a−b . . . b−a), which is twice as wide.
Arithmetic compression” is the method of coding based on dividing the unitary interval into sections, which length is proportional to the probability of the value to be coded.
“Accumulated frequency of the value” is a number which indicates how many times the value was previously meted.
“Recursive filter” is a filter based on summation of previous values weighted by exponentially decreasing coefficients. To avoid a large amount of summations and multiplications, the recursive filter calculates the current filter value using the linear combination of the previous filter result and the current value to be filtered.
“Scalefactor” is the value needed to rescale the MDCT coefficients. The resealing is implemented by the following equations for short and long blocks, respectively:

MDCT_rescaled=sign*MDKT^{4/3}*2^{1/4(global}_{_{—}}^{gain-210-8}*^{subblock}_{_{—}}^{gain)}*2^{-(scalefac}_{_{—}}^{multiplier}*^{scalefactor}_{_{—}}^{s)}

MDCT_rescaled=sign*MDCT^{4/3}*2^{1/4(global}_{_{—}}^{gain-210)}*2^{-(scalefac}_{_{—}}^{multiplier}*^{scalefactor}_{_{—}}^{i+preflag}*^{pretab)}

is the normalizing multiplier for MDCT data.
“Band” is the group of frequency values in one or several frames (for example with indices: 0 . . . 31, 32 . . . 63, 64 . . . 127, 128 . . . 255, 256 . . . 575).
“Series” is the set of values in different frequencies, but in one frame.
“Columns” is the set of values in one frequency but in different frames.
“ESC-symbol” is the value chosen so that all values larger than it are assumed to have approximately identical probability.
“ESC-sequence” is the sequence of ESC-symbol and the difference between the current value and ESC-symbol.
“ESC-sequence coding”is the method of coding values with small probability, which consists of coding the ESC-symbol and the difference between the value to be coded and the ESC-symbol.
“Table” is the table of probabilities of the value to be coded. The probability table can be changed during the coding process. The more symbols that were coded using the table, the larger is the probability of this value.
“Statistics” is the last values stored in a buffer.
“The MTF-3” (Move To Front 3 last values) is a method of coding by which the last three different values coded are remembered and placed in stack, then coded with the probability of the location where they are stored plus their own probability, while all other values are coded with their own probabilities.
“Aggressiveness” is the parameter that shows the frequency of table rescaling.
“Symbol” is the value to be coded, e.g. scalefactor, MDCT coefficient etc.
“Binary code” is a code which consists of 0 and 1. This code needs N bits for encoding 2̂N different values. The value can be calculated as: Value=ᵢΣaᵢ2ⁱ.
“Unary code”—is a code, which consists of N symbols “1” and one symbol “0” in the end (if the value isn't the largest; for the largest value the last “0” isn't necessary). This code needs from 1 to N bits for encoding N different values. The value can be calculated as Value=ᵢΣaᵢ.
“e” is the base of natural logarithm, e=2.718281828.

### Entropy Compression

In the preferred embodiment the entropy compression stage of the invention comprises the following components:
1. MDCT data compression:
   a. The method scheme;
   b. The method description;
   c. Sign prediction algorithm;
   d. count0 boundary;
   e. Magnitude prediction algorithm;
   f. ESC-sequence employment;
   g. First iteration employment.
2. Scalefactors usage and compression.

### MDCT Data Scheme

Input data have a complicated structure and consist of five parts. The first type of data is the MDCT coefficients. MDCT coefficients have the following format: Values in the range of −8207 . . . 8207 are grouped into series of 576 values each. The number of series containing these values is limited with 32-bit arithmetic usage. The algorithm works by the series, that is the coding of each series is started only after all previous series are coded. Each series is divided into 5 bands as shown in Table 1, each “band” is a subset of data within the series. The division into bands does not depend upon the values, but depends only upon the place of the symbol in the series. For example, the first band starts at the zero position and ends at the 31st position, composed of a group of values dependent upon their series position. The series in each band are shown in Table 1.

TABLE 1

| Band number | First position in band | Last position in band |
|---|---|---|
| 0 | 0 | 31 |
| 1 | 32 | 63 |
| 2 | 64 | 127 |
| 3 | 128 | 255 |
| 4 | 256 | 575 |

The algorithm separately treats magnitudes and signs of values, because there is no correlation between them. Encoding the sign “0” corresponds to “+” and “1” corresponds to “−”. If the magnitude is equal to 0, the sign is not written to output stream.

If (MDCT<0) then Magnitude=−MDCT else Magnitude=MDCT

If (MDCT<0) then Sign=1 else Sign=0

### MDCT Compression Method

The algorithm is based on any suitable arithmetic compression procedure. Input data for this procedure are the following: the number of possible values for the symbol to be compressed, the table of appearance frequencies (a probability table analogue) and the sum frequency (total weight of the table). The table is generated during the compression process as described below. The coding (compression) of the data is thus reduced to the optimum table fitting for each magnitude or sign to be compressed, by implementation of arithmetical compression. The optimal table is taken in dependence of the filtered MDCT coefficient to the maximal MDCT coefficient in the band ratio.

The table refresh frequency is controlled by the “aggressiveness” parameter. When the sum of all accumulated frequencies in the table exceeds the aggressiveness parameter, the entire table is divided by 2 (rescaled). The “aggressiveness” parameter is constant and is fitted for better compression.

The procedure implementing the arithmetic compression calculates the left and the right ranges for the range coder, to be used for further compression. It can be called by the following string:
EncodeONEint(int a, int*Cnt, int step, int Size, int totfreq)
in which:
int a=the value to be encoded;
int*Cnt=the table of accumulated frequencies pointer;
int step=the value, which is added to the appearance frequency of the symbol after coding;
int Size=the table size;
int totfreq=the whole frequency of the table equal to the sum of all its elements and the size of the table.
The table is pre-initialized by the information gained at the first iteration, and then the appearance frequency of the symbol to be compressed is increased each time when the appropriate symbol is coded.

During the coding process the procedure uses a table of accumulated frequencies which differs from the original table by increasing each accumulated frequency by 1. This increment is implemented to avoid the possibility of a zero probability for a symbol.

There is a restriction for the mechanism of suboptimum table fitting. The algorithm must be reproducible while decoding. The original series is transformed into the series of magnitudes and signs by the rule described above. Tables during the initialization process are filled (8 to 11 items per band) by Gaussian distribution according to the formula:

$$P ( x ) = A exp [ - \frac{{( x - d )}^{2}}{2 S} ] ,$$

where
d, S are defined parameters and A is normalization coefficient. Such a distribution approximates accumulation by the file distribution tables, described below (different bands for each file of MDCT data).

### Sign Prediction Algorithm

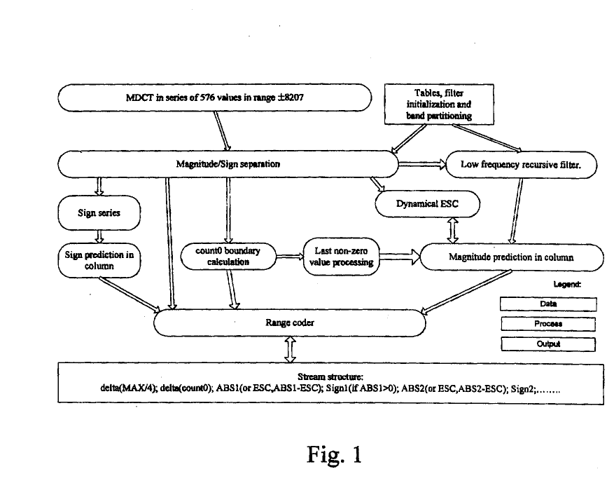

Considering the values signs distribution for different columns of MDCT data, FIGS. 2A to 2F illustrate the dependencies of the sum of signs (“+”+1, “−”=−1 to the sum) on the number of the series (designated “row number” in FIGS. 1A to 2F) for 576 columns. Each plot corresponds to a real melody.

The independent behaviour of the first sign column is clear in these plots. For most melodies the first sign column generally has the same value for all series, so this sign column is coded separately from the other columns using the compression algorithm.

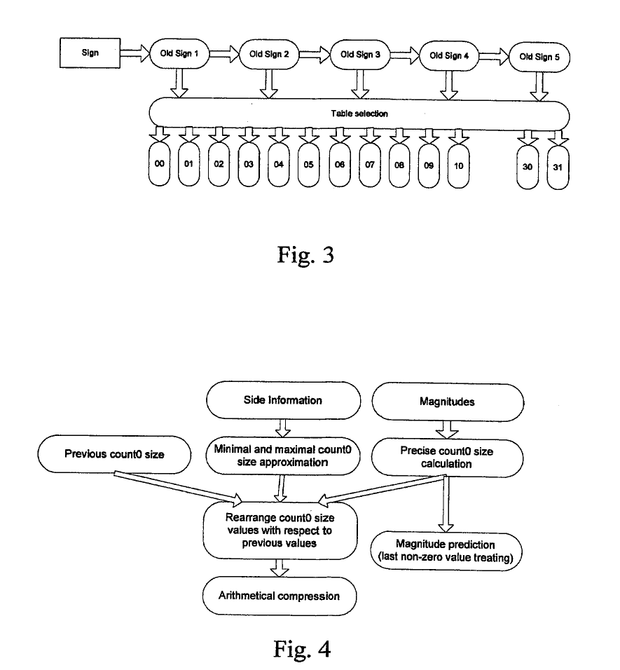

Other sign columns behave chaotically. There is a slight dependence of the signs in these columns on the sequence of previous signs in the same column. The table number for sign compression depends upon the sequence of previous signs, as shown in Table 2 and FIG. 3.

TABLE 2

| Sequence of signs in column | Numerical equivalence | Table Number |
|---|---|---|
| +++++ | 00000 | 0 |
| ++++− | 00001 | 1 |
| +++−+ | 00010 | 2 |
| +++−− | 00011 | 3 |
| ++−++ | 00100 | 4 |
| . . . | . . . | . . . |
| −−−−− | 11111 | 31 |

“count0” boundary

The position where the last non-zero MDCT-coefficient is located plus one, is the “count0 boundary”. The magnitude distribution through the series has a tendency to include high values at the start of the series and to decrease to low values at the end of the series. Therefore, it is more efficient to point to the location of the last non-zero element than to automatically include the last data points of a series in the compression, since they may all be zero. The count0 boundary is coded as the difference between the current count0 boundary and the count0 boundary in previous series.

Because of the Delta-coding used for count0 boundary compression it is often more efficient to shift the count0 boundary artificially to the right for some numbers and to compress all zeros between the last non-zero MDCT coefficient and the artificially shifted count0 boundary. However, storing the precise last non-zero value position can eliminate the asymmetry of such an approach also, coding the last non-zero value with a smaller table can eliminate the redundancy of this approach. The last non-zero value cannot be equal to zero, so the zero value probability must be zero. This approach allows the compression ratio to be increased.

### Magnitude Prediction Method

The prediction algorithm uses the filtered value of the previous MDCT-coefficient in the same column (Filtered_value). The filtering is carried out by the low-frequency recursive filter. The table with which the number will be coded is selected depending on the comparison of the Filtered_value with the largest value in the band (MaxBand). The concordance coefficients K=Filtered_value/MaxBand are fixed for each band. The current coefficient distribution is illustrated in Table 3.

TABLE 3

| | Table | | | | | | | | | | |
|---|---|---|---|---|---|---|---|---|---|---|---|
| Band | 0 | 1 | 2 | 3 | 4 | 5 | 6 | 7 | 8 | 9 | 10 |
| Band 0 | 0 | 0.01 | 0.03 | 0.06 | 0.1 | 0.2 | 0.3 | 0.6 | 1.0 | 2.0 | . . . |
| Band 1 | 0 | 0.05 | 0.1 | 0.2 | 0.3 | 0.5 | 0.7 | 1.0 | 3.0 | 5.0 | . . . |
| Band 2 | 0 | 0.05 | 0.1 | 0.2 | 0.3 | 0.5 | 0.7 | 1.0 | 3.0 | 5.0 | . . . |
| Band 3 | 0 | 0.01 | 0.03 | 0.06 | 0.1 | 0.2 | 0.3 | 0.6 | 1.0 | . . . | — |

The standard recursive filter is used to carry out the low frequency filtering. Coefficients of the recursive filter are selected to decrease the value meted 7 frames previously in e times:

Filtered_value[t+dt]=Filtered_value[t]*6/7+Last_value[t]*1/7

When using integer values, to reduce the rounding error the Last_value is multiplied by 10:

Filtered_value[t+dt]=(Filtered_value[t]*6+Last_value[t]*10)/7;

The maximal values in each band are calculated during the first iteration.

To code a “high amplitude” frame it is desirable to use the previous value in the same frame. It is filtered by means of a low frequency recursive filter:

Filtered_value[f+df]=(Filtered_value[f]*4+Last_value[f]*10)/5;

and the filtered value is compared with the filtered value of the MDCT coefficient from the previous frame. It can be compared not only with the filtered value, but with the filtered value plus the square root of dispersion. The dispersion is calculated by the following equation:

Dispersion=<valuê2>−<value>̂2,

where < . . . >—is a low frequency filtering (by means of the recursive filter).
Value_sq=Valuê2;
Filtered_value_sq=Filtered_value_sq*ê(−2f)+Value_sq*(1−ê(−2f));
Filtered_value=Filtered_value*ê(−f)+Value*(1−ê(−f))
Dispersion=Filtered_value_sq−(Filtered_valuê2)

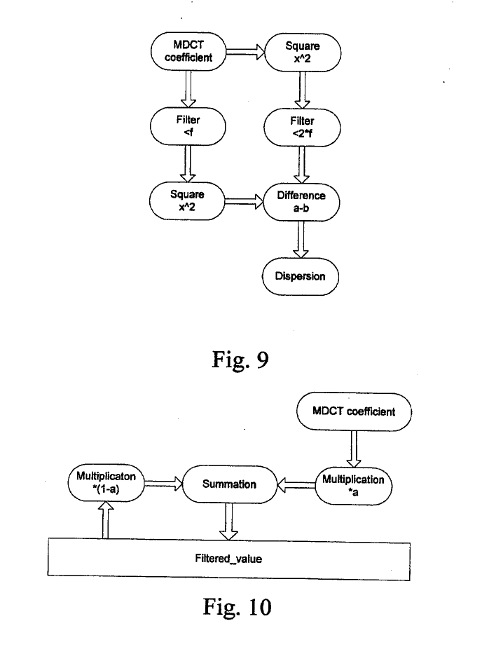

After the comparison, in different cases different sets of tables are picked out. The recursive filtering is shown in FIG. 10 and the dispersion calculation is shown in FIG. 9.

To improve the compression ratio, the mixing of tables can be implemented. If the ratio of the filtered MDCT coefficient to the maximal MDCT coefficient is not exactly the value from table 3, a linear combination of two tables can be used for encoding. The coefficients of the linear combination are calculated as a simple linear approximation:

W1=(Filtered_MDCT−Left_boundary)/(Right_boundary−Left_boundary)

W2=(Right_boundary−Filtered_MDCT)/(Right_boundary−Left_boundary)

Mixed_table=Left_table*W2+Right_table*W1

### (Where Left_boundary<Filtered_MDCT<Right_boundary)

To increase compression ratio for binary data (where the data can be 0 or 1) a simple limitation of the largest and the lowest probability of 1 and 0 can be implemented. To reduce the MDCT coefficient encoding to the binary data encoding, each MDCT coefficient can be converted to binary or unary code. In fact, it is valuable to implement unary code for some small values (for example, for values 0 . . . 15). For some larger values it's preferable to use binary code (for example, for values 16 . . . 527). It is preferable to compress the largest values with the equiprobable table (for example, for values 528 . . . 8207).

### ESC-Sequence Usage

Sometimes it is necessary to encode a large value with the table, even though there is a small probability of this value occurring. In such cases it can be more efficient to use the ESC-sequence and to write the encoded ESC-value and the difference between that value and the ESC-value to the output stream. The ESC-value is fitted dynamically for each table from the ratio

Price(ESC)+Price(Value−ESC)<Price(Value)

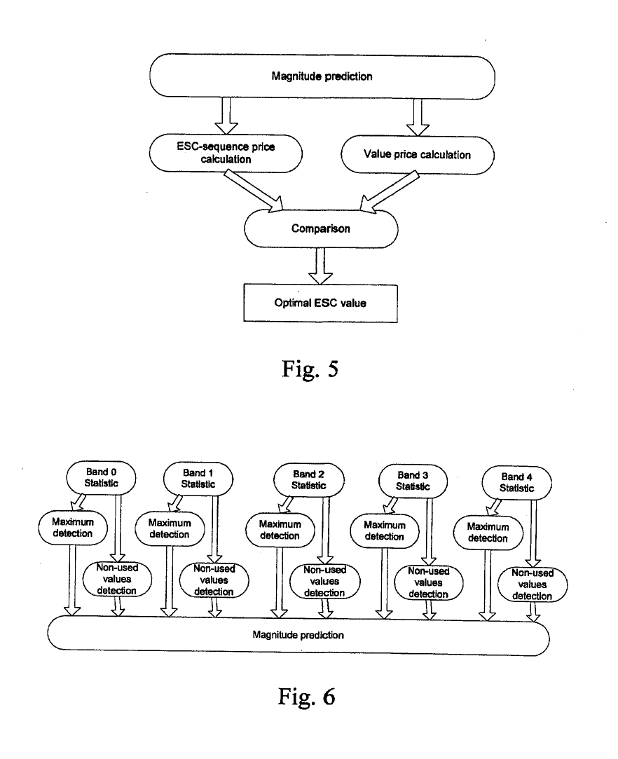

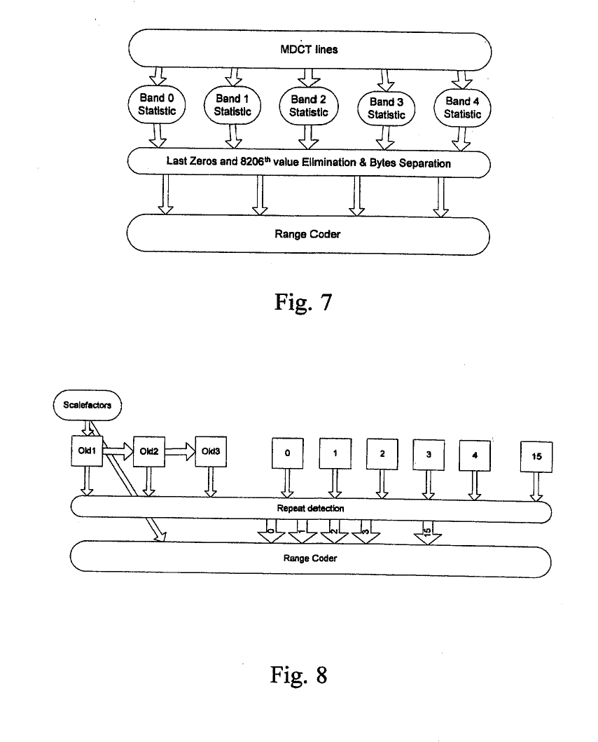

This inequality corresponds to the discontinuous variety of ESC-values. Thus, the selection of the optimal ESC-value is not a single-value problem. The optimal ESC-value is located between the smallest ESC-value that satisfies this inequality and the biggest ESC-value that does not satisfy this inequality. The optimal ESC-value calculation process is shown in FIG. 5.

When using the arithmetic coder to code the data, high values have a low probability of occurring (they were in previous data only once, or there are no such values at all). This low probability can be inadvertently reduced to zero due to truncation error. To prevent this error, and to compress such values more effectively, ESC-coding is used. Namely, one of the possible values is taken as the ESC-symbol and all values after it and the ESC-symbol essentially are coded with the same probability. In this algorithm the probability of these values are added and are said to be the probability of the ESC-symbol. When a data point has a value that is greater than or equal to the ESC-symbol, the ESC-symbol is coded with the probability of the ESC-symbol and the difference of the value and the ESC-symbol (zero included) is coded by the equiprobable table. (The coding with equiprobable table is a particular case of arithmetic compression, which uses a probability table in which all probabilities are equal) The selection of the ESC-symbol is carried out by minimizing the integral of function ƒ(x)*log(p(x)), where p(x) is the probability to be coded with, and ƒ(x) is the estimated probability, i.e. the smoothed probability, collected through the process of coding. The smoothing is an ordinary calculation of the mean value of the probabilities of the five nearest values. However, when the highest and non-possible values are known with high precision, ESC-coding is not necessary.

### The First Iteration Employment

The first iteration is used for general statistic collection. This statistic is used for initialization of tables before the second iteration, for maximum detection in each band, and for detection of non-used values. The general statistic is collected for each band separately (0 . . . 31, 32 . . . 63, 64 . . . 127, 128 . . . 255, 256 . . . 575), as shown in FIG. 6. The general statistic can be changed during the coding. When the value is coded, the corresponding number in the general statistic (with the same value and in the same band) is decreased by 1.

The general statistic is stored in a compressed file. It contains numbers, which indicates how many times each value appeared in each band. The number of series is known, so the sum of all numbers for each band can be calculated as the product of the series number to the band width (bands have the following width: first—32, second—32, third—64, forth—128, fifth—320). As the number of MDCT-lines is known, the last zero-values in the file do not need to be stored. The 8206th value is not stored even if it is not zero, because it can be reconstructed correctly as the difference between the sum of all values (which is known) and the sum of all values except the 8206th (which were stored before). The table is compressed by arithmetic compression with four different tables for each byte of 32-bit words of statistic.

When decoding it is necessary to reconstruct the last zeros and the 8206th value. When storing such a statistic some redundancy is introduced in the output file. To eliminate the redundancy unused values are excluded from the table when coding the absolute values of the MDCT coefficients.

### Scalefactors Usage and Compression

There is a redundancy of scalefactor, in that when the scalefactor is known not all MDCT coefficients are possible. For example, when the scalefactor is not the smallest, all MDCT coefficients in the band of this scalefactor cannot be small because in such a case the scalefactor would have to be smaller. So when the last value of the MDCT coefficient is coded the low values from the table can be discarded when all previous values were small. For low bit rates the scalefactor precision is artificially reduced to achieve higher compression. The context model uses not only time correlation but also frequency correlation. Preferably the MTF-3 method is applied in the temporal domain to increase the compression rate of scalefactors.

### Frequency Reconstruction

Frequency construction comprises the following components:
1. Analysis of the input signal
2. Synthesis of high frequencies
3. Analysis of generated high frequencies
4. Extrapolation of parameters

### Analysis of the Input Signal

The first stage of the reconstruction of the audio file according to the method of the invention is the analysis of the sound file to be improved, or of the input audio stream, passed from the decoder. The analysis comprises two stages: time-frequency decompositions and parameter estimation.

There are two types of time-frequency decompositions that are performed during the analysis stage. The first type is the oversampled windowed Fast Fourier Transform (FFT) filterbank, which is time-frequency aligned with the filterbank used in the reconstruction phase: the size of the window is small enough (around 5 to 10 ms) to provide a sufficient time resolution. This filterbank is used for the estimation of the time-frequency amplitude envelope (described below). The second filterbank is a simple windowed FFT with a longer time window. This filterbank provides fine frequency resolution for the tonality estimation (described below).

The parameters estimated from the input audio are the time-frequency amplitude envelope and the degree of tonality. The amplitude envelope is a modulus of the corresponding filterbank coefficients, obtained from the first filterbank. The tonality is estimated from the magnitude spectrum of a second filterbank. Several tonality estimates are currently elaborated. The estimator that is preferred for use in the invention calculates the ratio of the maximal spectral magnitude value over the specified frequency range to the total energy in the specified frequency range. The higher this ratio, the higher the degree of tonality is. The frequency range used for estimation of the tonality is [F/2,F], where F is the cut-off frequency of the given audio file or of the input audio stream. The magnitude spectrum undergoes a “whitening” modification before calculation of the tonality. The purpose of the whitening modification is to increase the robustness of the estimator in case of a low degree of tonality. The whitening modification comprises multiplication of the spectral magnitude array by sqrt(f), where f is the frequency. This operation converts the pink noise spectrum into a white noise spectrum and lowers the tonality degree for the naturally non-tonal pink noise.

The output of the analysis block provides the estimates of amplitude envelope and tonality, comprising a 2D time-frequency array of amplitudes and 1D array of tonality variations in time.

### Synthesis of High Frequencies

The synthesis of high frequencies comprises the following steps:

1. The input audio is split into several frequency bands by means of a crossover. If the cut-off frequency is denoted as F and the desired number of bands is 2N+1, then the crossover bands are assigned with the following frequencies: [F/2−dF/2, F/2+dF/2], [F/2,F/2+dF], [F/2+3dF/2, F/2+5dF/2], . . . , [F−dF/2, F−dF/2]. The crossover comprises band-pass FIR filters designed using a windowed sync method. The size of the window is around 10 ms. The window used is preferably Kaiser (beta =9). The filtered full-rate signals comprise outputs of the crossover.

2. Each of the output crossover output signals is passed through a nonlinear wave-shaping distortion effect. The distortion effect is provided by the following formula: y(t)=F(x(t)), where F is the non-linear transformation. The simplest form of F (not used in the invention) is a simple clipping, i.e. F=x(t) when abs(x(t))<=A, and F=±A where A is some arbitrary threshold amplitude. This distortion generates an infinite row of harmonics of the input signal, which is undesirable for digital audio processing because higher harmonics may be aliased about the Nyquist frequency and generate undesirable intermodulation distortion. To prevent this distortion, the invention preferably employs a special kind of distortion function in the form of Chebychev polynomials, which allows control over the exact number of generated harmonics. For the present invention the second-order polynomial is suitable, so y(t) F(x(t))=×(t)̂2 is a useful formula. It generates the second harmonic of the input signals.

3. The resulting distorted bands are summed up to form the first estimate of the reconstructed high frequencies in [F,2F] frequency range. The intermodulation distortion products are out of the [F,2F] range, so they can be filtered out by simply excluding all frequencies above 2F.

### Analysis of Generated High Frequencies

The generated high frequencies are analyzed in the same way as the analysis of the input audio signal (step 1, above). Since these two steps of analysis are identical, they can be combined into one analysis step. At the output of this analysis step the estimates of amplitude envelope and tonality of the generated high frequencies are obtained.

### Extrapolation of Parameters

The parameters detected from step 1 are extrapolated into the domain of high frequencies. The following extrapolation methods are preferred:

For extrapolation of the amplitude envelope, detect the slope of the amplitude envelope in the frequency range [F/2, . . . ,F]. The calculation is done as follows.

1. Spectral whitening modification, multiplication of magnitudes by sqrt(f) for each frequency point.

2. Detection of the slope over a wide frequency range:

$${S}_{1} = {( \sqrt{\frac{{\sum }_{f = \frac{F - N}{2}}^{\frac{F + N}{2}} {X}_{f}^{2}}{{\sum }_{f = F - 2 N}^{F - N} {X}_{f}^{2}}} )}^{\frac{1}{K}}$$

where K is the number of filterbank frequency bins between F/2 and F, and N is the number of bins used for energy averaging. Here it is assumed to be K/4.

3. Detection of a slope over a narrower frequency range:

$${S}_{2} = {( \sqrt{\frac{{\sum }_{f = \frac{3 F - N}{4}}^{\frac{3 F + N}{4}} {X}_{f}^{2}}{{\sum }_{f = F - \frac{N}{4}}^{F - \frac{3 N}{4}} {X}_{f}^{2}}} )}^{\frac{2}{K}}$$

4. The final slope is calculated as

$$S = \frac{{S}_{1} + {S}_{2}}{2}$$

5. The slope is linearly extrapolated in the decibel domain to the higher frequencies.

6. The resulting slope is smoothed in time using a recursive low-pass filter:

Xsmoothed[t] [f]=αX[t] [f]+(1−α)Xsmoothed[t−1] [f].

For extrapolation of the tonality a simple zero-order extrapolation is used. The tonality of the reconstructed high-frequency signal should be equal to the tonality of the [F/2,F] band.

### Adjustment of Higher Frequencies

Having obtained the estimated parameters of the reconstructed high frequency component, the final step is to adjust the estimated parameters to approximate the actual parameters.

The first adjustment to be undertaken is the tonality adjustment. There are two methods for adjustment of tonality. The first is to adjust the number of bands used in the crossover in step 2. The second method is a direct adjustment in the domain of filterbank coefficients. It is performed by means of amplification of peaks in a spectrum. Two possibilities exist for this: either each coefficient is scaled proportionally to its energy, or only peaks in a spectrum are located and amplified. The peaks are located using the X[f−2]<X[f−1]<=X[f]>=X[f+1]>X[f+2] criterion for magnitudes of adjacent filterbank frequency bins.

The second adjustment is the adjustment of the amplitude envelope. This adjustment is performed in the domain of filterbank coefficients. The difference between the extrapolated envelope and the real estimated envelope is calculated and then smoothed in frequency by means of a 2-pass simple zero-phase low-pass recursive filter: Xsmoothed[f]=βX[f]+(1−β)Xsmoothed[f−1] and Xsmoothed[f]=βX[f]+(1−β) Xsmoothed[f+1]. Then the smoothed correction amplitude envelope is applied to filterbank coefficients, i.e. the filterbank coefficients are multiplied by the magnitude correction coefficients.

Mixing with the Input Audio

The resulting reconstructed high-frequency signal, that contains no energy below F, is mixed with the input audio to form the final output signal of the algorithm. The process of mixing is just addition of two signals in time domain. Optionally, the amplitude coefficient A can be applied to the reconstructed high frequency signal in order to alter its amplitude according to user demand.

Various embodiments of the present invention having been thus described in detail by way of example, it will be apparent to those skilled in the art that variations and modifications may be made without departing from the invention. The invention includes all such variations and modifications as fall within the scope of the appended claims.

Applicant incorporates by reference Canadian Application Serial No. 02467466.

We claim:

1. A method for compressing an audio signal, comprising the steps of:
a. dividing spectral data corresponding to the audio signal into a plurality of frequency bands, each band corresponding to a different frequency range;
b. obtaining a plurality of the last Modified Discrete Cosine Transform (MDCT) coefficients corresponding to the spectral data for each frequency for each band; and
c. compressing the spectral data using a prediction of coefficient values in a plurality of preceding frames of audio data by calculating a mean value of the plurality of last MDCT coefficients.

2. The method of claim 1 comprising the further step of:
d. further compressing the spectral data using one or more context models or arithmetic compression, or both.

3. The method of claim 2 comprising the further step of:
e. further compressing the spectral data using an MDCT sign prediction algorithm and ESC-sequence.

4. The method of claim 3 comprising the further step of:
f. further compressing the spectral data using a count0 selection method.

5. The method of claim 2 wherein step (d) comprises the step of comparing a filtered value of an Nth MDCT coefficient with a largest value of all MDCT coefficients obtained from a first iteration, in the band containing N.

6. The method of claim 3 wherein step (d) comprises the step of calculating a ratio of the filtered value of the Nth MDCT coefficient with the largest value of all MDCT coefficients, to determine a number of tables to be used for arithmetic compression.

7. A method for increasing a compression ratio in the compression of an audio signal, comprising compressing scalefactors using MTF-3 method.

8. A method of reconstructing an audio signal from a set of compressed audio data corresponding to an original audio signal, comprising the steps of:
a. time-frequency decomposing the compressed audio data,
b. estimating parameters from the audio data comprising at least an amplitude envelope estimated from a modulus of a first set of corresponding filterbank coefficients and a tonality estimated from a magnitude spectrum of a second set of corresponding filterbank coefficients; and
c. synthesizing high frequency components of the audio signal by:
i) dividing the audio data into several frequency bands,
ii) passing each frequency band through a nonlinear wave-shaping distortion effect to generate distorted frequency bands, and
iii) summing the distorted frequency bands to form an estimate of the high frequency components.

9. The method of claim 8 wherein step (a) comprises the substep of passing the audio data through at least one band-pass FIR filter.

10. The method of claim 8 wherein step (b) comprises the substeps of, in any order, i) estimating the time-frequency amplitude envelope using an oversampled windowed Fast Fourier Transform (FFT) filterbank, and ii) estimating tonality using a windowed FFT.

11. The method of claim 8 for enhancing high frequency components of an audio signal, comprising first compressing the audio signal before decompressing the audio signal and reconstructing high frequency components.
